(19) United States
(12) Patent Application Publication
(10) Pub. No.: US 2025/0128608 A1
(43) Pub. Date: Apr. 24, 2025

(54) Aerodynamic Turbine and System for Vehicle Battery Charging

(71) Applicant: Scott Malloy, Clearwater, FL (US)

(72) Inventor: Scott Malloy, Clearwater, FL (US)

(21) Appl. No.: 18/907,874

(22) Filed: Oct. 7, 2024

Related U.S. Application Data
(60) Provisional application No. 63/591,619, filed on Oct. 19, 2023.

(51) Int. Cl. B60L 8/00; B60L 53/22; F03D 9/11; F03D 9/32

(52) U.S. Cl. CPC B60L 8/006; B60L 53/22; F03D 9/11; F03D 9/32; B60L 2210/30; F05B 2240/941

(57) ABSTRACT

A vehicle-compatible air turbine device and system designed to enhance the charging capabilities of batteries or capacitors in hybrid or electric vehicles is disclosed. The turbine device includes a magnetic stator with embedded magnets and coils, and an impeller fan with a plurality of blades arranged radially around a central hub. The turbine device is adapted to capture airflow generated by vehicle movement and converting it into rotational energy to induce an electric current in the stator. The electric current is rectified and used to charge the vehicle's battery or capacitor. The system further includes an adaptive control module to optimize turbine operation based on vehicle speed and battery charge levels. Additionally, the turbine device can be installed in other applications, such as powering streetlights in tunnels using airflow from passing vehicles or wind.

### CROSS-REFERENCE TO RELATED APPLICATION

The present application claims priority to, and the benefit of, U.S. Provisional Application No. 63/591,619 which was filed on Oct. 19, 2023, and is incorporated herein by reference in its entirety.

### FIELD OF THE INVENTION

The present invention generally relates to the field of vehicular energy systems. More specifically, the present invention relates to a vehicle-compatible air turbine device designed to enhance the charging capabilities of batteries or capacitors in hybrid and electric vehicles by harnessing the kinetic energy of airflow. The system consists of lightweight, durable turbines with magnetic stators and impeller fans, strategically mounted on the vehicle to capture and convert airflow into electrical energy. This energy is then used to charge the vehicle's battery or capacitor, thereby extending the vehicle's range and improving overall efficiency. Accordingly, the present disclosure makes specific reference thereto. Nonetheless, it is to be appreciated that aspects of the present invention are also equally applicable to other like applications, devices, and methods of manufacture.

### BACKGROUND

By way of background, standard vehicles primarily operate using fossil fuels such as gasoline and diesel. Such vehicles have long been used for personal and commercial transportation. However, the reliance on fossil fuels poses significant environmental and health risks due to the emission of greenhouse gases and other pollutants. The emissions contribute to air pollution, climate change, and various health problems, making fossil fuel-based transportation increasingly unsustainable in the long term.

In response to the concerns of standard vehicles, electric vehicles (EVs) have gained popularity in the last few years. EVs produce no tailpipe emissions, reducing their environmental impact and helping to improve air quality. Despite their environmental benefits, electric vehicles face challenges related to battery capacity and range. Current battery technology often limits the distance an EV can travel on a single charge, which becomes a significant issue for long-distance travel. Drivers are often forced to seek out charging stations along highways, which can be inconvenient, particularly in areas where charging infrastructure is sparse or unavailable. The limited availability of charging stations can lead to frequent and prolonged stops during travel, disrupting the journey and causing frustration for drivers. Additionally, the costs associated with charging at public stations, especially over long trips, can accumulate, making electric vehicle travel expensive and less convenient.

Hybrid vehicles use a combination of fossil fuel and electric power and attempt to address some of these issues by extending range and improving fuel efficiency. However, some hybrid vehicles may experience reduced performance, particularly when the gasoline engine is relied upon more heavily during long trips. Due to the problems faced by individuals with various vehicles, individuals desire a solution that can extend the range of electric and hybrid vehicles without relying solely on external charging stations or fossil fuels.

Therefore, there exists a long-felt need in the art for a system that can effectively extend the range and enhance the efficiency of hybrid and electric vehicles by providing additional charging capabilities. There is also a long-felt need in the art for a solution that can harness the natural airflow over and around a moving vehicle to generate electricity. Additionally, there is a long-felt need in the art for a charging system that can be seamlessly integrated into existing vehicle designs without adding significant weight or complexity. Moreover, there is a long-felt need in the art a system that increases the range of hybrid and electric vehicles, especially beneficial when traveling long distances. Furthermore, there is a long-felt need in the art for a system that not only generates additional power but also contributes to the overall efficiency and sustainability of the vehicle. Finally, there is a long-felt need in the art for an innovative approach to vehicle energy management that maximizes the use of available kinetic energy, thereby offering a cost-effective and environmentally friendly alternative to traditional energy generation methods in vehicles.

The subject matter disclosed and claimed herein, in one embodiment thereof, comprises a vehicle-compatible air turbine device and system designed to enhance the charging capabilities of batteries or capacitors in hybrid or electric vehicles. The turbine device includes a magnetic stator with embedded magnets and coils and is designed to generate electricity when the vehicle is in motion. An impeller fan with multiple blades is strategically positioned within the stator to capture and convert airflow into rotational energy. The rotation of the impeller fan drives the magnetic stator, inducing an electric current which is rectified and conditioned to charge the vehicle's battery or capacitor. The system includes vibration-resistant brackets for secure mounting on the vehicle's chassis or body panels, and a noise-dampening design to reduce any operational noise generated by the turbine.

In this manner, the vehicle-compatible air turbine system of the present invention accomplishes all of the foregoing objectives and provides a novel solution for extending the range and efficiency of hybrid and electric vehicles. By utilizing the kinetic energy of airflow over and around the vehicle, the system generates additional electricity without relying on external charging stations, thereby reducing the frequency of charging stops during travel. The use of lightweight, durable materials ensures that the system does not significantly add to the vehicle's weight or complexity, making it suitable for both new vehicle designs and aftermarket installations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle-compatible air turbine device for enhancing the charging capabilities of batteries or capacitors in a hybrid or electric vehicle. The vehicle-compatible air turbine device includes a magnetic stator having a plurality of magnets disposed on an inner surface, the magnetic stator is configured to generate electricity when exposed to rotational motion. An impeller fan is disposed inside the magnetic stator and is adapted to function as a rotor, the impeller fan includes a plurality of blades arranged in a radial pattern around a central hub. One or more vibration-resistant brackets are included for mounting the turbine device to a vehicle chassis or body panel, wherein the turbine device is designed to convert airflow caused by vehicle movement into rotational energy, which drives the impeller fan to induce an electric current in the magnetic stator for charging the vehicle's battery or capacitor.

In yet another embodiment, a vehicular battery charging system for a hybrid or electric vehicle is disclosed. The system includes a plurality of air turbine devices mounted on a vehicle, each turbine device comprises a magnetic stator having a plurality of magnets disposed on an inner surface, configured to generate electricity, an impeller fan disposed inside the magnetic stator and adapted to function as a rotor, the impeller fan includes a plurality of blades arranged in a radial pattern around a central hub. A rectification module is configured to convert the generated alternating current (AC) from the turbine devices into direct current (DC) for charging a vehicle battery or capacitor. An adaptive control module is adapted to monitor vehicle speed and battery charge levels to optimize the operation of the turbine devices and provide fail-safes to disconnect the turbines during low-speed operation or in the event of an overcharge.

In another embodiment, a method for generating electricity in a hybrid or electric vehicle using an air turbine device is disclosed. The method comprises the steps of mounting one or more air turbine devices on a vehicle, each turbine device comprising a magnetic stator and an impeller fan, capturing airflow caused by vehicle movement to rotate the impeller fan within each turbine device, driving the magnetic stator with the rotating impeller fan to generate an electric current, rectifying and regulating the generated electric current to match the charging requirements (i.e., specifications) of a vehicle battery or capacitor, and supplying the rectified electric current to the vehicle battery or capacitor for charging. The method also includes the step of automatically stopping the operation of the air turbine devices during low-speed operation of the vehicle or when battery charging is not needed.

In still another embodiment, a street light system is disclosed. The system includes a plurality of air turbine devices installed in a tunnel; a rectification module configured to convert the generated alternating current (AC) from the turbine devices into direct current (DC) for powering streetlights, wherein the air turbine devices are designed to harness airflow caused by moving vehicles or wind in the tunnel to generate electricity for the streetlights.

In yet another aspect, the impeller fan blades are curved with an airfoil cross-section to maximize efficiency in converting airflow into rotational energy.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of vehicle compatible air turbine device of the present invention in accordance with the disclosed structure;

FIG. 2 illustrates a perspective view showing a plurality of air turbine devices of the present invention mounted onto a vehicle in accordance with the disclosed structure;

FIG. 3 illustrates a perspective view showing details of the vehicular battery charging airflow system of the present invention in accordance with one embodiment of the present invention;

FIG. 4 illustrates an exemplary turbine device associated with the throttle system of the vehicle in accordance with the disclosed structure;

FIG. 5 illustrates a perspective view showing a plurality of turbine devices of the present invention installed in a tunnel for providing electric power to streetlights in accordance with the disclosed structure; and

FIG. 6 illustrates a flow chart depicting a process of generation of electricity using the turbine device and system of the present invention in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that can effectively extend the range and enhance the efficiency of hybrid and electric vehicles by providing additional charging capabilities. There is also a long-felt need in the art for a solution that can harness the natural airflow over and around a moving vehicle to generate electricity. Additionally, there is a long-felt need in the art for a charging system that can be seamlessly integrated into existing vehicle designs without adding significant weight or complexity. Moreover, there is a long-felt need in the art a system that increases the range of hybrid and electric vehicles, especially beneficial when traveling long distances. Furthermore, there is a long-felt need in the art for a system that not only generates additional power but also contributes to the overall efficiency and sustainability of the vehicle. Finally, there is a long-felt need in the art for an innovative approach to vehicle energy management that maximizes the use of available kinetic energy, thereby offering a cost-effective and environmentally friendly alternative to traditional energy generation methods in vehicles.

The present invention, in one exemplary embodiment, is a vehicle-compatible air turbine device. The vehicle-compatible air turbine device includes a magnetic stator having a plurality of magnets disposed on an inner surface, the magnetic stator is configured to generate electricity when exposed to rotational motion. An impeller fan is disposed inside the magnetic stator and is adapted to function as a rotor, the impeller fan includes a plurality of blades arranged in a radial pattern around a central hub. One or more vibration-resistant brackets includes for mounting the turbine device to a vehicle chassis or body panel, wherein the turbine device is designed to convert airflow caused by vehicle movement into rotational energy, which drives the impeller fan to induce an electric current in the magnetic stator for charging the vehicle's battery or capacitor.

Reference will now be made in detail to the present preferred embodiments of the invention, examples of which are illustrated in the accompanying drawings. Wherever possible, the same reference numerals are used in the drawings and the description to refer to the same or like parts.

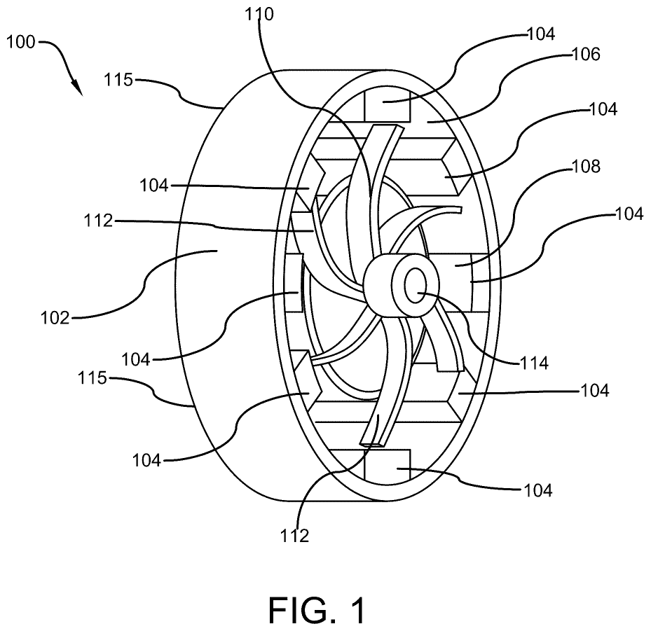

Referring initially to the drawings, FIG. 1 illustrates a perspective view of vehicle compatible air turbine device of the present invention in accordance with the disclosed structure. The aerodynamic energy harvesting turbine 100 of the present invention is designed to enhance the charging capabilities of batteries or capacitors in a hybrid or electric vehicle (EV) by harnessing the kinetic energy of airflow over and around the vehicle. More specifically, the turbine device 100 is designed to spin efficiently with minimal airflow and is made from lightweight, durable materials such as carbon fiber or aluminum to reduce weight and resistance. The turbine device 100 includes a magnetic stator 102. The magnetic stator 102 is preferably circular but can be of any geometric shape. The magnetic stator 102 includes a plurality of magnets 104 disposed on the inner surface 106 thereof. The magnets 104 included embedded coils 108 for generating electricity when a vehicle in which the aerodynamic energy harvesting turbine 100 is mounted thereto moves in a forward direction.

An impeller fan 110 is disposed inside the stator 102 and is adapted to function as a rotor. The impeller fan 110 includes a plurality of blades 112 or vanes arranged in a radial pattern around a central hub 114. The blades 112 can be designed as straight, curved, or backward inclined, depending on the application. When a vehicle moves, the air flows over the surface of the vehicle and naturally produces drag. The strategically placed a plurality of turbine devices 100 capture this airflow and the impeller fan 110 of each turbine rotates. The rotation of the turbine blades 112 drives the magnetic stator 102 to induce an electric current in the coils 108. The current is then rectified and conditioned to charge the vehicle's battery or capacitor.

The stator 102 can have a diameter from about 2 inches to about 8 inches depending on available space on the vehicle. The impeller fan 110 can be made from lightweight, high-strength materials such as carbon fiber-reinforced polymer (CFRP) or aluminum to reduce weight and inertia. Further, the impeller fan 110 can have 2 to 8 blades 112 and the blades 112 are preferably curved with an airfoil cross-section to maximize efficiency in converting airflow into rotational energy. In the preferred embodiment, the turbine device 100 is designed to operate efficiently at speeds from 1,000 RPM to 10,000 RPM, depending on vehicle speed and airflow. The turbine device 100 is designed to generate voltage in the range of 12V to 48V DC which is compatible with most automotive electrical systems.

The turbine device 100 includes one or more vibration-resistant brackets 115 for mounting the turbine device 100 to a vehicle's chassis or body panels, with provisions for easy maintenance and replacement. Further, the turbine device 100 has a noise-dampening design to minimize any additional noise generated by the spinning turbines.

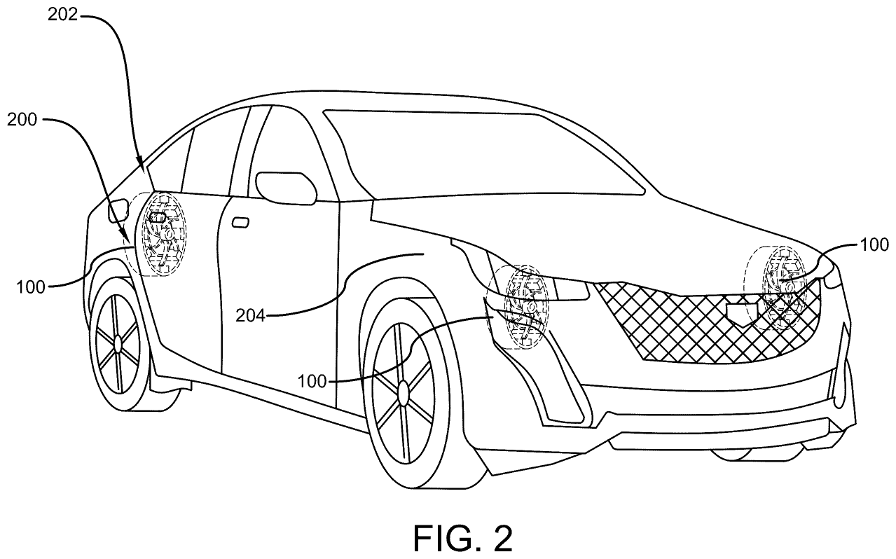

FIG. 2 illustrates a perspective view showing a plurality of air turbine devices of the present invention mounted onto a vehicle in accordance with the disclosed structure. As illustrated, the vehicular battery charging system 200 includes a plurality of turbine devices 100 mounted onto a vehicle 202. The turbine devices 100 can be mounted during manufacturing of a new vehicle or can also be mounted to an existing vehicle as an aftermarket product. The turbines 100 are preferably mounted along the vehicle's bodyline 204 where airflow is most efficient, such as the edges of the roof, hood, or sides of the vehicle 202. The turbines 100 can also be integrated into the air intake system of the vehicle, where the turbines 100 can use the airflow entering the engine such as in hybrid vehicles or cooling system such as in EVs.

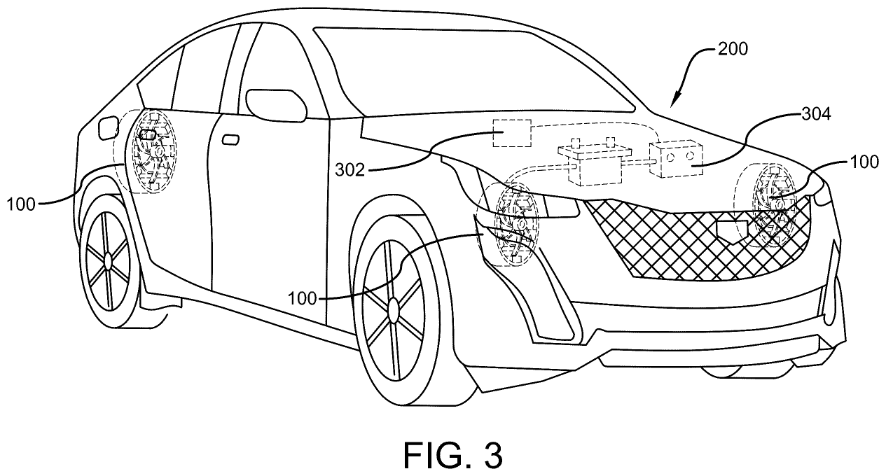

Each turbine is mounted such that the as the vehicle 202 moves, each turbine captures the airflow and converts it into rotational motion. The rotating blades 112 drives the magnetic stators, inducing an electric current in the coils. The current is used for charging battery of the vehicle as described in FIG. 3.

FIG. 3 illustrates a perspective view showing details of the vehicular battery charging airflow system of the present invention in accordance with one embodiment of the present invention. The system 200 includes a rectification module 302 which includes at least one rectifier and converter. The rectification module 302 converts the alternating current (AC) voltage generated by the turbines to direct current (DC) and then regulates the converted DC to match the requirements (i.e., specifications) of the vehicular battery 306 or capacitor's charging requirements (i.e., specifications). An adaptive control module 304 is adapted to monitor vehicle speed and battery charge levels to optimize the operation of the turbines. The adaptive control module 304 automatically stops operation of the turbines 100 during low-speed operation of the vehicle or when battery charging is not needed. The adaptive control module 304 also provides fail-safes to disconnect turbines in the event of an overcharge or electrical fault, preventing damage to the vehicle's powertrain. In the present embodiment, only one turbine is connected to the battery 306 for the simplified presentation, however, it will be understood that all the turbines are internally connected to the battery 306 via the control module 304.

In some embodiments of the present invention, one or more turbines can be connected to the vehicle's throttle system. When the driver accelerates and throttle opens, airflow increases and the turbines rotate faster, thereby generating more electricity. Throttle connected turbines can be useful during highway driving, where higher speeds generate more airflow, leading to more significant energy capture. It will be apparent to a user that by converting aerodynamic drag into usable energy, the system 200 extends the range of hybrid or electric vehicles.

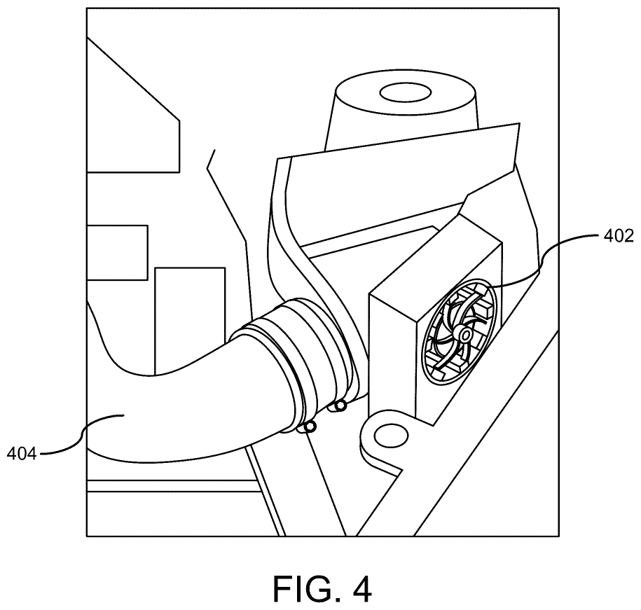

FIG. 4 illustrates an exemplary turbine device associated with the throttle system of the vehicle in accordance with the disclosed structure. As illustrated, the turbine 402 which is same as the turbine 100 of other embodiments of the present invention is associated with the throttle system 404 of the vehicle 202. The turbine 402 rotates at a higher RPM when the vehicle moves at a higher speed, thereby producing more electric power to recharge vehicular battery or capacitors.

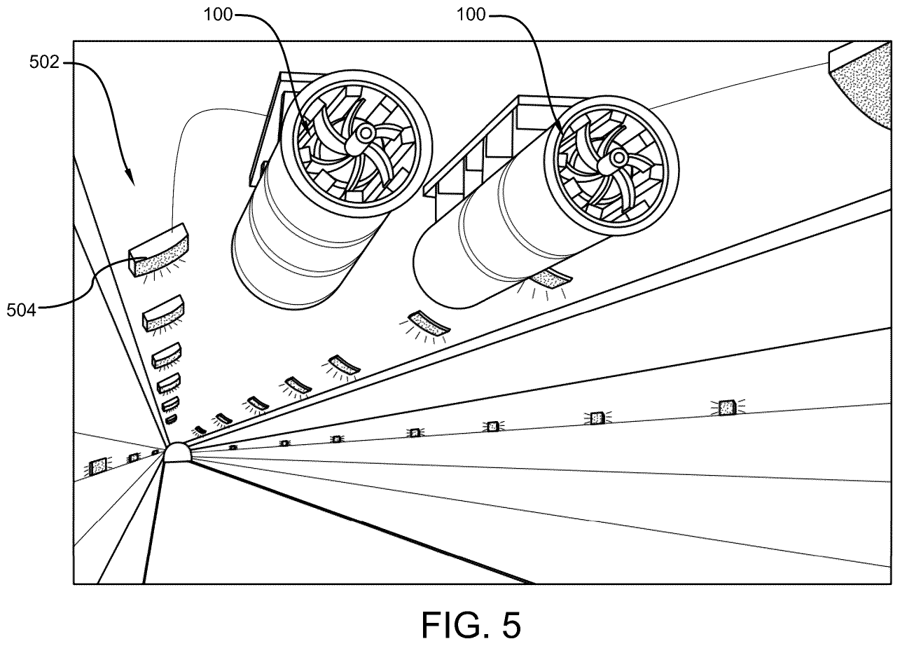

FIG. 5 illustrates a perspective view showing a plurality of air turbine devices of the present invention installed in a tunnel for providing electric power to streetlights in accordance with the disclosed structure. The turbine devices 100 of the present invention can be used in different applications for providing electric power. In the present embodiment, the turbine devices 100 are installed in a tunnel 502 such that air from the moving vehicles or wind rotates the impeller fan 110 to produce electric power through the stator 102. The electric power can be rectified and used for operating streetlights 504 or any other similar operation.

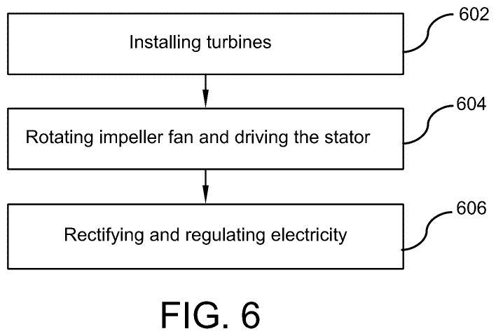

FIG. 6 illustrates a flow chart depicting a process of generation of electricity using the vehicle-compatible air turbine device and system of the present invention in accordance with one embodiment of the present invention. Initially, one or more turbine devices 100 are installed at appropriate locations such as in a vehicle (Step 602). Then, during use, when airflow passes through the turbine device 100, the impeller fan 110 rotates and drives the magnets of the stator 102 to produce electricity (Step 604). Thereafter, the electricity is rectified and regulated for the specific application and is supplied for use (Step 606).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle-compatible air turbine device”, “aerodynamic energy harvesting turbine”, and “turbine device” are interchangeable and refer to the aerodynamic vehicle battery charging turbine device 100 of the present invention. Similarly, as used herein “vehicle-compatible air turbine system”, “aerodynamic energy harvesting turbine system”, “system” are interchangeable and refer to the vehicle-compatible air turbine system 200 of the present invention.

Notwithstanding the forgoing, the aerodynamic vehicle battery charging turbine device 100 and the vehicle-compatible air turbine system 200 of the present invention can be of any suitable size and configuration as is known in the art without affecting the overall concept of the invention, provided that it accomplishes the above stated objectives. One of ordinary skill in the art will appreciate that the aerodynamic vehicle battery charging turbine device 100 and the vehicle-compatible air turbine system 200 as shown in the FIGS. are for illustrative purposes only, and that many other sizes and shapes of the aerodynamic vehicle battery charging turbine device 100 and the vehicle-compatible air turbine system 200 are well within the scope of the present disclosure. Although the dimensions of the aerodynamic vehicle battery charging turbine device 100 and the vehicle-compatible air turbine system 200 are important design parameters for user convenience, the aerodynamic vehicle battery charging turbine device 100 and the vehicle-compatible air turbine system 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle energy harvesting turbine comprising:
a turbine;
an impeller fan;
a plurality of blades;
a magnetic stator; and
a plurality of magnets;
wherein said plurality of magnets mounted on an inner surface of said magnetic stator;
wherein each of said plurality of magnets having an embedded coil;
wherein said impeller fan including said plurality of blades turnable in response to airflow over and around a vehicle during forward motion of the vehicle; and
further wherein said turbine generating electricity in response to said turning of said plurality of blades.

2. The vehicle energy harvesting turbine of claim 1, wherein said turbine connected to an EV battery for charging the EV battery with said electricity generated from said turning of said plurality of blades.

3. The vehicle energy harvesting turbine of claim 2, wherein said plurality of blades having a material selected from the group consisting of a carbon fiber and an aluminum.

4. The vehicle energy harvesting turbine of claim 3, wherein and said impeller fan and said plurality of blades inside said magnetic stator.

5. The vehicle energy harvesting turbine of claim 4, wherein said plurality of blades arranged in a radial pattern around a central hub.

6. The vehicle energy harvesting turbine of claim 5, wherein each of said plurality of blades having a shape selected from the group consisting of a straight blade, a curved blade, and a backward-inclined blade.

7. The vehicle energy harvesting turbine of claim 6, wherein the rotation of said plurality of blades drives said magnetic stator for inducing an electric current in said coils.

8. The vehicle energy harvesting turbine of claim 7, wherein said magnetic stator having a diameter from 2 inches to 8 inches.

9. The vehicle energy harvesting turbine of claim 8, wherein said plurality of blades having between 2 and 8 blades.

10. The vehicle energy harvesting turbine of claim 9, wherein said impeller fan having an operational range from 1,000 RPM to 10,000 RPM.

11. The vehicle energy harvesting turbine of claim 10, wherein said turbine generating voltage in the range from 12V to 48V DC.

12. A vehicle energy harvesting turbine comprising:
a turbine comprising an impeller fan, a plurality of blades, a magnetic stator and a plurality of magnets;
wherein said plurality of magnets are mounted on an inner surface of said magnetic stator;
wherein each of said plurality of magnets having an embedded coil;
wherein at least one said turbine mountable to a bodyline of a vehicle;
wherein said impeller fan including said plurality of blades turnable in response to airflow over and around the vehicle during forward motion of the vehicle; and
further wherein said turbine generating electricity in response to said turning of said plurality of blades.

13. The vehicle energy harvesting turbine of claim 12, wherein said at least one said turbine connected to an EV battery for charging the EV battery with said electricity generated from said turning of said plurality of blades.

14. The vehicle energy harvesting turbine of claim 12, wherein said plurality of blades having a material selected from the group consisting of a carbon fiber and an aluminum.

15. The vehicle energy harvesting turbine of claim 12, wherein and said impeller fan and said plurality of blades inside said magnetic stator.

16. The vehicle energy harvesting turbine of claim 12, wherein said plurality of blades arranged in a radial pattern around a central hub.

17. The vehicle energy harvesting turbine of claim 12, wherein each of said plurality of blades having a shape selected from the group consisting of a straight blade, a curved blade, and a backward-inclined blade.

18. The vehicle energy harvesting turbine of claim 12, wherein the rotation of said plurality of blades drives said magnetic stator for inducing an electric current in said coils.

19. An electric vehicle battery charging turbine comprising:
a turbine comprising an impeller fan, a plurality of blades, a magnetic stator, and a plurality of magnets; and
a rectifier;
wherein said plurality of magnets mounted on an inner surface of said magnetic stator;
wherein each of said plurality of magnets having an embedded coil;
wherein at least one said turbine mountable to a bodyline of a vehicle;
wherein said impeller fan including said plurality of blades turnable in response to airflow over and around the vehicle during forward motion of the vehicle;
wherein said at least one said turbine generating electricity in response to said turning of said plurality of blades;
wherein said rectifier converts alternating current (AC) generated by said at least one said turbine to direct current (DC); and
further wherein said rectifier regulates said converted DC to match a specification of the EV battery.

20. The electric vehicle battery charging turbine of claim 19 further comprising an adaptive control module, wherein said adaptive control module stops operation of said at least one said turbines during low-speed operation of the vehicle.
